(19) United States
(12) Patent Application Publication
(10) Pub. No.: US 2009/0303515 A1
(43) Pub. Date: Dec. 10, 2009

(54) PRINTER DRIVER PROGRAM, AND PRINTING INSTRUCTION DEVICE

(75) Inventor: Yoshiaki Imai, Okaya-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/463,959

(22) Filed: May 11, 2009

(30) Foreign Application Priority Data
Jun. 10, 2008 (JP) 2008-152033

(51) Int. Cl. G06F 3/12

(52) U.S. Cl. 358/1.13

(57) ABSTRACT

A printer driver program is disclosed that allows a host device to perform a printing instruction process for a plurality of models of printers. The printer driver program includes a program part that allows the host device to perform a process of holding product specification information provided from a manufacturer of the printers for each of the models and latest configuration information which is property information about each of the printers and is settable by a user, and a program part that allows the host device to perform a process of generating and displaying a user interface screen based on the product specification information and the configuration information relating to a selected printer in response to a request made by the user.

### BACKGROUND

1. Technical Field

The present invention relates to a printing instruction device for performing a printing instruction process and a computer readable medium encoded a printer driver program capable of allowing a host device to perform a printing instruction process, particularly a printer driver program adaptable to a plurality of models of printers and capable of improving usability.

2. Related Art

In general, a driver program for a printer is installed in a host device such as a personal computer. The host device instructs a printer to perform printing by processing in accordance with the driver program. When performing the instruction for printing, print data for the printer including image data to be printed and a control command for printing conditions are generated, and are transmitted to the printer in accordance with the driver program.

The above printing conditions include paper size, kind of paper, resolution, and paper feeding device to be used. In general, a user may select each of the items of the printing conditions to set its content when inputting instructions for printing. In paper feeding devices provided to printers, some of them are provided thereto as standard devices, and some of them are selectively provided thereto as optional devices. Since a content of an option at a time when setting the printing condition may be changed depending on the presence or absence of an optional device, an interface for allowing a user to change the setting of a hardware environment of a printer at that time may be provided to the printer.

Some printer drivers can be commonly used for a plurality of models of printers as described in non-patented related art. The related art includes, for example, descriptions in pages 3 and 14 in a document of “EPSON printer driver EPSON ESC/Page printers for Windows NT4.0”, by EPSON SALES JAPAN CORPORATION, at a site of <URL: http://www.i-love epson.co.jp/download2/readme/1.13dh/963521.html>[online], 2006, searched on Dec. 26, 2007, via the Internet. Concerning common drivers heretofore employed, in an interface screen for environment setting, functions provided to all of the models as standard functions and functions provided to some of the models as optional functions are all indicated in order to make the common printer driver applicable to all of the models to be used, and allowing selection of a certain one of the models.

In recent years, networking has been increasingly used in an office environment. In such an environment, computers are coupled to a plurality of printers via a network and can use a plurality of models of printers.

In the above environment, when providing a printer driver program for each of models of printers to a host device in an existing manner, a plurality of programs need to be installed in the host device, the number of resources for a computer needs to be consistent with the number of programs, and many images such as icons, symbols, or character stings indicative of the printers are displayed as the selection candidates in the event of selection of a printer, which makes operation of the printers troublesome for a user.

In a case where an existing common printer driver as described above can be used, since an interface is applicable to all of the corresponding models, there is a possibility that a displayed content is not always consistent with a specification (function) of that model of a printer to be actually used. At that time, there is a possibility that a content (function) set or selected by a user is not actually provided to the printer. In the above case, the user cannot obtain a desired printed result. In addition, since the latest content is held as a set configuration content with respect to the above described environment setting by the existing common driver, the set configuration content should be changed when changing the model of the printer to be used, resulting in troublesome operations having to be performed by the user.

### SUMMARY

An advantage of some aspects of the invention is that it provides a printing instruction device that performs a printing instruction process for a plurality of models of printers, and capable of improving usability. The printing instruction device according to a first aspect of the invention, is adapted to perform a printing instruction process for a plurality of models of printers.

The printing instruction device includes a data storage unit that stores product specification information provided from a manufacturer of the printers by each of the models and configuration information which is able to be set by a user and is the latest information regarding property information about the printers and a control unit that generates and displays a user interface screen based on the product specification information and the configuration information in accordance with a selected printer in response to a request made by the user.

The printing instruction device according to the first aspect of the invention further may include a update unit that updates the information about the selected printer to be information about the printer which is a target of the printing instruction process or the setting process of the configuration information every time the processes are performed, and then to hold the updated information.

In the printing instruction device according to the first aspect of the invention, the request made by the user may be a request for setting of the configuration information or a request for setting of a printing condition when inputting the instruction for printing.

In the printing instruction device according to the first aspect of the invention, the configuration information may include information relating to an attachment state of an optional device of the printer and information relating to a printing condition selected as a default when inputting the instruction for printing.

A computer readable medium encoded a printer driver program according to a second aspect of the invention is adapted to allows a host device to perform a printing instruction process for a plurality of models of printers. The printer driver program includes a program part that allows the host device to perform a process of holding product specification information provided from a manufacturer of the printers for each of the models and latest configuration information which is property information about each of the printers and is settable by a and a program part that allows the host device to perform a process of generating and displaying a user interface screen based on the product specification information and the configuration information relating to a selected printer in response to a request made by the user.

### BRIEF DESCRIPTION OF THE DRAWINGS

The invention will be described with reference to the accompanying drawings, wherein like numbers reference like elements.

FIG. 1 is a structural block diagram showing a host computer having a common printer driver program according to an embodiment of the invention.

FIGS. 2A through 2D are explanatory views exemplarily showing the content of an initial property information file 14 and a latest property information file.

FIG. 3 is a flowchart exemplarily showing a processing sequence performed by the common printer driver 12 in a case where a user sets configuration information.

FIGS. 4A through 4D are schematic views exemplarily illustrating user interface screens for environment setting.

FIG. 5 is a schematic view exemplarily illustrating a user interface screen for model switching.

FIG. 6 is a flowchart exemplarily showing a processing sequence performed by the common printer driver 12 in a case where the driver 12 receives a print request and gives a printing instruction to a printer 2.

FIGS. 7A and 7B are schematic views exemplarily illustrating user interface screens for condition setting.

### DESCRIPTION OF EXEMPLARY EMBODIMENTS

The preferred embodiments according to the invention will be described with reference to the accompanying drawings. It should be noted that embodiments described below do not limit the scope of the invention.

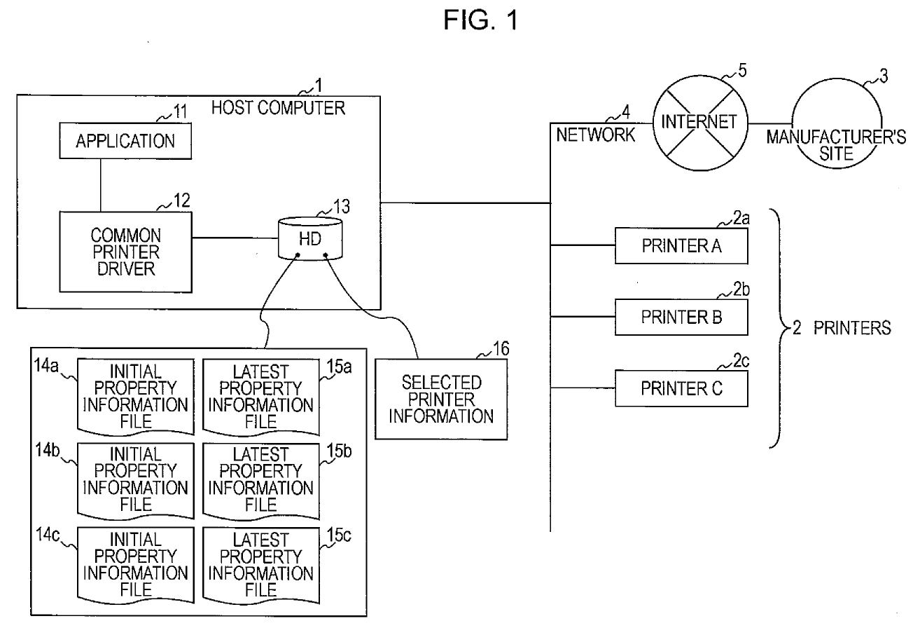

FIG. 1 is a structural block diagram illustrating a host computer having a common printer driver using a printer driver program according to an embodiment of the invention. A printer driver program 12 shown in FIG. 1 according to the embodiment of the invention allows a host computer 1 to store product specification information provided by a manufacturer of printers for each model in terms of a plurality of applicable models of printers and a hardware environment settable by a user. The common printer driver 12 generates an interface screen in accordance with the above product specification information and the above configuration information so as to improve the usability in a case where a plurality of models of printers are used.

As shown in FIG. 1, the host computer 1 having the common printer driver 12 according to the embodiment is coupled to a plurality of printers 2 via a network 4. In the embodiment, the host computer 1 is coupled to three printers 2a, 2b and 2c of different models, and the host computer 1 can use the above printers. The model names of the printers 2a, 2b and 2c are “printer A”, “printer B” and “printer C”, respectively. Each of the printers 2 performs a printing process in accordance with a print command output from the host computer 1.

In addition, the host computer 1 is coupled to a site 3 of the manufacturer of the printers 2 via a network 4 and the Internet 5. The manufacturer's site 3 is adapted to provide various information to users of the printers 2. A driver program of the common printer driver 12 and an initial property information file 14 described later are provided to the host computer 1 from the above site. The manufacturer's site 3 is hosted by a computer system and a database.

Next, the host computer 1 is a host device constituted by a personal computer capable of instructing the printer 2 to perform printing. Consequently, the host computer 1 is equipped with a CPU, a ROM, a RAM, a display device and an input device (not shown). As shown in FIG. 1, an application 11, the common printer driver 12 and an HD 13 are provided to the host computer 1.

The application 11 is a printing request source, for example, formed of a document producing software. The application 11 gives data to be printed in a prescribed format to the common printer driver 12.

The common printer driver 12 receives a printing request from the application 11, and generates print data for giving instructions about the requested printing to the printers 2, and transmits the data to the printers 2. While, as described above, the host computer 1 can use the three printers 2a, 2b and 2c, the printer driver 12 is one which can be commonly used for the three models of the printers 2.

The common printer driver 12 is equipped with an interface by which a user can set contents of various properties of each of the printers 2. The common printer driver 12 generates an interface screen in accordance with a request for setting made by the user and causes the host computer 1 to store the set configuration content in response to a setting operation performed by the user via the screen. When the common printer driver 12 receives the print request, it generates and displays an interface screen for allowing the user to set various items of the printing conditions for the printing, and then the printing conditions corresponding to the user's operations are reflected in the print data to be transmitted to the printers 2.

The common printer driver 12 is equipped with the above two kinds of interface screens. The interface screens for one of the printers 2 currently selected are generated based on the initial property information file 14 or a latest property information file 15 stored in the host computer 1 for each model of the printers 2. This is an essential characteristic of the common printer driver 12, and specific processes of the common printer driver 12 will be described later.

The common printer driver 12 may be configured of a driver program for giving instructions regarding a sequence of the above processes and a control device (the above described CPU) for executing the processes in accordance with the program. The driver program can be downloaded to the host computer 1 from the manufacturer's site 3 via the Internet 5.

The HD 13 is a hard disk device of the host computer 1 for storing various data and programs. As shown in FIG. 1, the HD 13 stores the initial property information file 14, the latest property information file 15 and selected printer information 16.

The initial property information file 14 is prepared for each of the models of the printers 2 and has the product specification information about the model and the configuration information that the user can set. The product specification information is fixed property information predetermined for the model including information about, for example, a usable paper size, a kind of paper, a paper feeding device provided as a standard device and a feeding device attachable as an optional device. On the other hand, the configuration information is property information indicating the status of the printer at the current time as well as a hardware environment of the printer at the current time or a content selected in a default manner as a printing condition for printing. The configuration information includes, for example, information about an optional paper feeding device attached at that time and information about an address on the network 4 of the printer. In the configuration information, an initial value determined by the manufacturer of the printers 2 is stored in the initial property information file 14.

When either one of the printers 2 is installed and the driver program of the common printer driver 12 is downloaded, the initial property information file 14 is downloaded to the host computer 1 via the Internet 5 from the manufacturer's site 3 to be stored in the HD 13. In the embodiment, initial property information files 14a, 14b and 14c are stored in the HD 13 for the respective three printers 2a, 2b and 2c as shown in FIG. 1.

The latest property information file 15 includes the product specification information and the latest configuration information about the model of the printer, the product specification information and the latest configuration information being provided for each of the models of the printers 2. The files 15a, 15b and 15c and the initial property information files 14a, 14b and 14c are respectively linked to each other and are stored in the HD 13 in accordance with the three printers 2a, 2b and 2c. The latest property information file 15 is produced when the user initially carries out a setting operation for setting the configuration information for each of the printers 2. After the latest property information file has been produced, the content is updated at every setting operation. A part of the file 15 relating to the product specification information is formed such that the content of the initial property information files 14 is copied thereto.

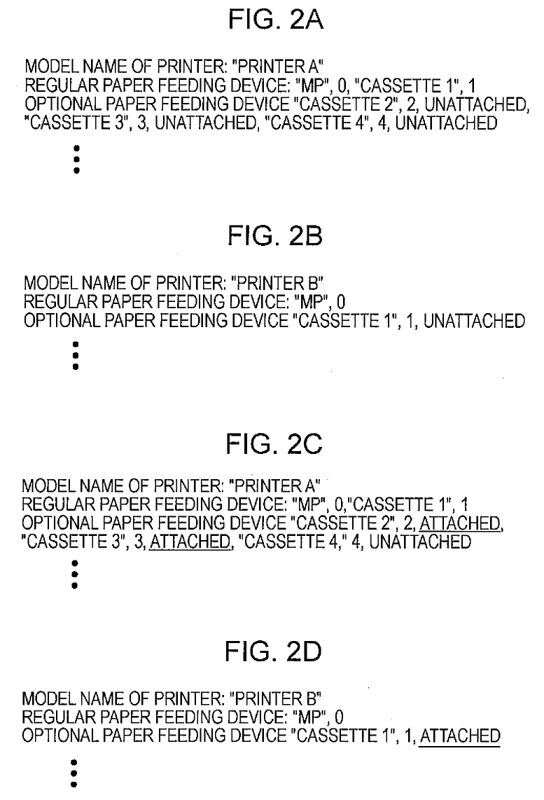

FIGS. 2A through 2D are explanatory views exemplarily showing the contents of the initial property information files 14 and the latest property information file 15. FIG. 2A shows a part of the initial property information file 14a, i.e., the initial property information file of the printer 2a (model name of “printer A”). The part indicated in FIG. 2A is information relating to a paper feeding device. It is indicated as the product specification information that there are devices of “MP” (a multipurpose paper feeding device) and “cassette 1” provided as standard paper feeding devices, and there are paper feeding devices of “cassette 2”, “cassette 3” and “cassette 4” selectively provided as optional devices. A character string of “unattached” indicated at the end of the character string of “cassette 2” means that the paper feeding device of “cassette 2” is not attached to the printer at that time, and such information corresponds to the above described configuration information. Here, the information is one in the initial property information file 14, the character string of “unattached” is a default initial data. A value of “0” indicated at the end of a character string of “MP” is a parameter indicative of the status of the paper feeding device. When the paper feeding device is selected when a printing instruction is issued, the corresponding parameter is embedded in the print data.

FIG. 2B shows a part of the initial property information file 14b for the printer 2b (model name of “printer B”) similarly to above. As can be understood from FIG. 2B, the number of standard paper feeding devices and optional paper feeding devices of the printer with the model name of “printer B” is smaller than the number of those of the printer with the model name of “printer A”.

FIG. 2C shows a part of the latest property information file 15a for the printer 2a (model name of “Printer A”) corresponding to the part shown in FIG. 2A. Here, underlined portions are different from portions in FIG. 2A. That is, FIG. 2C indicates the file which is the latest configuration information after the user carries out the setting operation. Therefore, it indicates that while the devices of “cassette 2” and “cassette 3” were in “unattached” states at the initial stage, they are in “attached” states at the present stage so that they are in operable states. The latest information about the above latest property information file 15 is used in the generation of the above described interface screen for the user.

FIG. 2D shows a part of the latest property information file 15b for the printer 2b (model name of “printer B”) corresponding to the part shown in FIG. 2B. Here, a content of an underlined portion is different from that of the portion in FIG. 2B. Similarly to the case of FIG. 2C, it indicates that it is in an “attached” state at the present stage so that it is in an operable state.

Next, the selected printer information 16 indicates the printer currently selected from among the printers 2. As described above, since the common printer driver 12 is adapted to perform processes of the three printers 2, it is necessary for efficient processing to set one of the printers 2 as a so-called current printer (selected printer). The information is updated to that of a certain one of the printers 2 set as a printing target every time the setting operation or the input of the printing instruction is carried out by the user.

Thus, the host computer 1 according to the embodiment having the above configuration as the printing instruction device for each of the printers 2, generates print data including image data to be printed and a control command in accordance with a print request issued from the application 11 and transmits the print data to a certain one of the printers 2, i.e., a target of the printing instruction, to allow the printer to perform the printing on a printing medium. In relation to the above processes, since the above common printer driver 12 has a specific characteristic in the process of generating a user interface, the characteristic is described below.

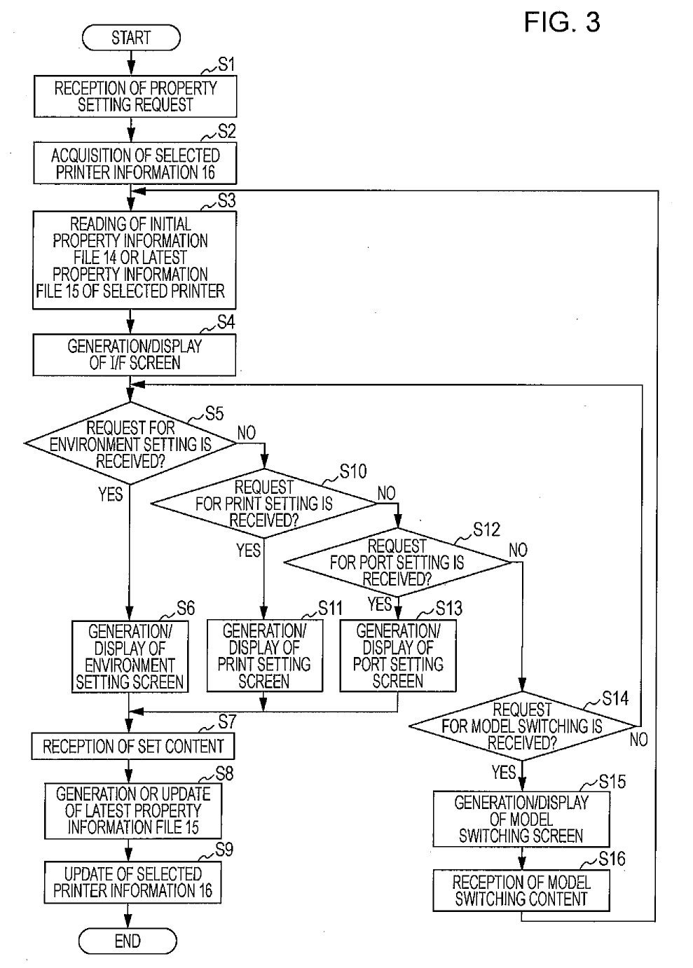

FIG. 3 is a flowchart exemplarily showing a processing sequence performed by the common printer driver 12 in a case where the user sets the above configuration information. When the user needs to update or confirm the content of the various configuration information, the user issues a request for the update or confirmation (property setting request) to the host computer 1. To be specific, for example, the user selects an icon representing the common printer driver 12 displayed on the display device of the host computer 1 and gives an instruction for setting the properties of the printers 2 by using the input device of the host computer 1.

When the common printer driver 12 receives the request (step S1), it acquires the selected printer information 16 stored in the HD 13 (step S2). The common printer driver 12 reads, from the HD 13, the initial property information file 14 or the latest property information file 15 of the model stored as the selected printer information 16, i.e., one of the printers 2 currently selected (step S3). Here, when the latest property information file 15 for the selected one of the printers 2 already exists, the content of the file is read. When the latest property information file 15 for the selected one of the printers 2 does not exist, the content of the initial property information file 14 is read. In a case where a model switching process described later has already been carried out, the content of the file for one of the printers 2 selected by the user is read.

After that, the common printer driver 12 generates a user interface screen for property setting based on the content of the read file and displays it on the display device of the host computer 1 (step 4). The user interface screen indicates the representative properties of the selected one of the printers 2 and a portion for accepting the request for setting each specific item to be set. With respect to the representative properties, the contents of items of the predetermined product specification information and the configuration information are acquired from the read initial property information file 14 or the read latest property information file 15 to be used. Concerning the portions for accepting the request for setting, for example, four portions of “environment setting”, “print setting”, “port setting” and “model switching” are prepared

Next, when the user designates the portion of “environment setting” to request that the setting of the environment is to be carried out, the request is received (Yes in step S5), and then an interface screen for the environment setting is generated and displayed on the display device (step S6). Here, the environment setting refers to setting of information mainly about the hardware environment such as attachment or detachment of an optional device to each of the printers 2. The common printer driver 12 acquires the information about the environment setting from the content of the read file 14 or 15 and generates a user interface screen thereof.

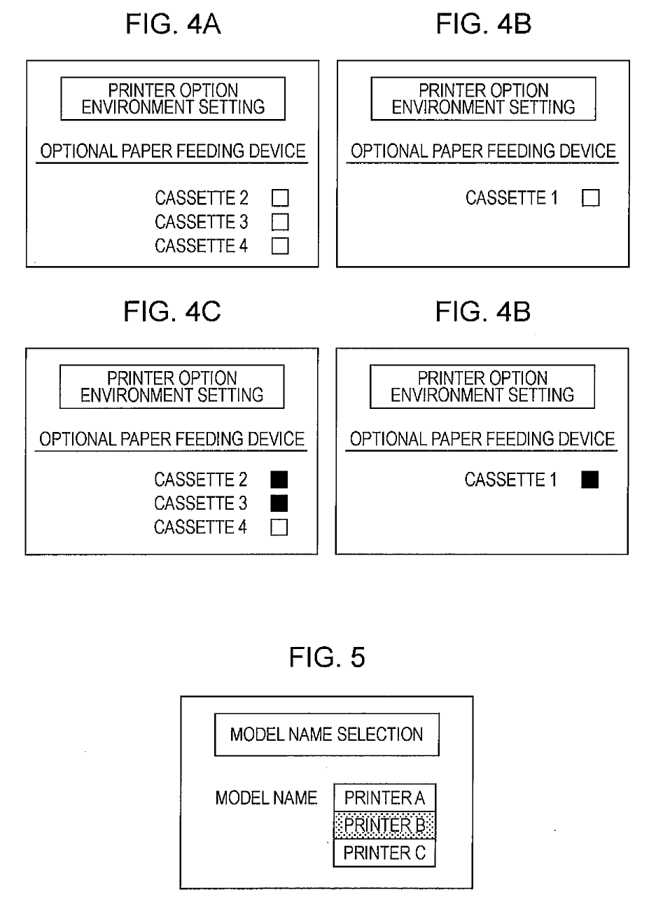

FIGS. 4A through 4D are schematic views for exemplarily showing the user interface screen for the environment setting. In each of FIGS. 4A through 4D, a portion for setting the optional paper feeding device in the environment setting is shown. When the selected one of the printers 2 is the printer 2a (model name of “printer A”), in the reading step of the file 14 or 15, the content of the initial property information file 14a or the latest property information file 15a is read. FIG. 4A shows a screen in a case that the initial property information file 14a is read in the above case.

In the above screen, each square symbol displayed at the right side of respective character strings indicative of optional paper feeding devices such as “cassette 2” indicates an attached or unattached state of the paper feeding device. As shown in the drawing, an unfilled square symbol indicates the unattached state. In the embodiment, the screen is formed on the basis of the content of FIG. 2A, and the indication of the attached state or unattached state of each optional paper feeding device corresponds to the content shown in FIG. 2A.

FIG. 4C shows the screen displayed in a case where the latest property information file 15a is read. In the above case, each square symbol displayed at the right side of each character string of “optional paper feeding devices” also indicates an attached or unattached state of the paper feeding device. A black solid square symbol indicates the attached state. Similarly to the case of FIG. 4A, in the embodiment, the screen is formed on the basis of the content shown in FIG. 2C, and the indication of the attached or unattached state of each optional paper feeding device corresponds to the content shown of FIG. 2C. That is, it indicates that the paper feeding device of “cassette 2” and “cassette 3” are attached and the paper feeding device of “cassette 4” is unattached.

FIGS. 4B and 4D, respectively, show cases in which the initial property information file 14b is read and the latest property information file 15b is read, in a case where the selected one of the printers 2 is the printer 2b (model name of “printer B”). In the above cases, the states correspond to the content of FIG. 2B and the content of FIG. 2D, respectively, similarly to the cases shown in FIGS. 4A and 4C.

When the user would like to change the indicated set content of the configuration information in the displayed screen, the user may designate the square symbol by using the input device of the host computer 1 to switch the indicated status of attachment or unattachment to the opposite one. The common printer driver 12 receives the content set by the user's input operation (step S7). In the case that the latest property information file 15 does not exist, the common printer driver 12 generates the latest property information file 15 to store it in the HD 13. In the case that the file 15 already exist, the common printer driver 12 performs the process of updating the content correlated to the set portion to the received content (step S8).

In the case shown in FIG. 4A, when, for example, the user carries out the setting operation for setting the paper feeding devices of “cassette 2” and “cassette 3” to be in the attached state, the latest property information file 15a having the content of FIG. 2C is generated and stored in HD 13.

After that, the common printer driver 12 performs the updating process such that the selected printer information 16 is set so as to designate one of the printers 2 to which the setting operation is carried out (step S9). When the model switching process is not performed, the selected printer information 16 is not changed by the above updating process.

Thus, the process in the case of the environment setting is completed.

On the other hand, turning to step 4, when the user designates a portion of “print setting” in the displayed screen to make a request for print setting, the common printer driver 12 receives the request (No in step S5, Yes in step S10), generates a user interface screen for print setting and displays the screen on the display device (step S11). Here, in the print setting, when there are some options for each item of the printing conditions, a default data can be set as the selected content. The common printer driver 12 acquires information relating to the print setting from the content of the read file 14 or 15 and generates a user interface screen similar to that in the case of the environment setting.

When the user carries out the setting operation while viewing the displayed screen, the content is received as in the case of the environment setting, and then the generation or updating of the latest property information file 15 based on the content is performed (steps S7 and S8). For example, the setting is carried out in the above process for print setting such that a size of A3 is selected as a default data for the printing condition of paper size in the printing, and then the content is set to the latest property information file 15. After that, as in the case of the environment setting, the updating process of the selected printer information 16 is performed (step S9).

Referring to step S4 again, when the user designates a portion of the above described “port setting” in the displayed screen to make a request for port setting, the common printer driver 12 receives the request (No in step S5, No in step S10, Yes in step S12), generates a user interface screen for port setting and displays it on the display device (step S13). Here, the port setting means a process of setting an address of each printer on the network. In the process, information relating to the port setting is acquired from the content of the file 14 or 15, and a user interface screen similar to that in the case of the environment setting is generated.

When the user carries out the setting operation with respect to the displayed screen, the content is received as in the case of the environment setting, and then the generating or updating of the latest property information file 15 is performed (steps S7 and S8). The port setting process is usually performed before each of the printers 2 is placed to be used. After that, as in the case of the environment setting, the updating process of the selected printer information 16 is performed (step S9).

In addition, referring to step S4 again, when the user designates a portion of the above described “model switching” in the displayed screen to make a request for model switching, the common printer driver 12 receives the request (No in step S5, No in step S10, No in step S12, Yes in step S14), generates a user interface screen for model switching and displays it on the display device (step S15). Here, the model switching means an operation and a process of switching (changing) one of the printers 2 (the model thereof) currently selected to another printer, for example, changing from the printer A to the printer B.

The common printer driver 12 accesses the initial property information file 14 and the latest property information file 15 stored in the HD 13 and acquires all of the model names of the usable printers 2, and then generates the user interface screen for model switching.

FIG. 5 is a schematic view for exemplarily showing the user interface screen for model switching. In this embodiment, printers having the model names of “printer A”, “printer B” and “printer C” can be used so that those model names are indicated in the interface screen as shown in FIG. 5.

when the user carries out the selecting operation of the model name while viewing the displayed screen, specifically, designates a portion of a desired printer name by using the input device, the common printer driver 12 receives the selected content (step S16), and then the process moves to step S3. After that, as described above, the processes starting from reading of the file 14 or 15 for one of the printers 2 with the currently selected model name are performed, and then the setting process for the one of the printers 2 after switching is performed.

Thus, the processes of setting the configuration information are completed. Note that, while it is described that the series of processes including each of the above described processes are finished in the description with reference to FIG. 3, it is possible that the series of the processes are not finished and the plurality of setting processes are continuously carried out until an instruction for finishing from the user is received.

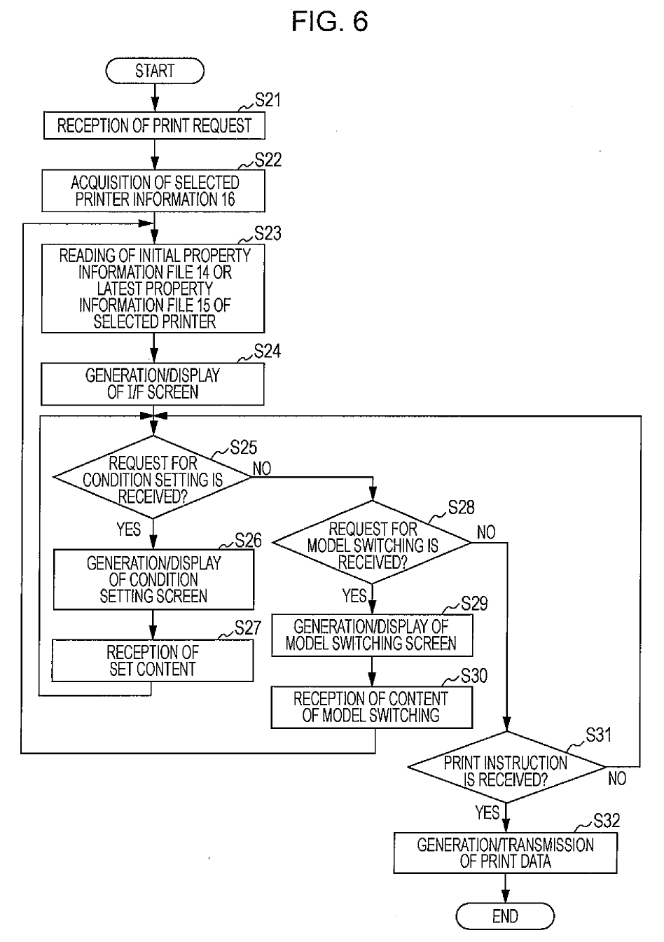

Next, a process in the instruction for printing is described below. FIG. 6 is a flowchart exemplarily showing a processing sequence in a case where the common printer driver 12 receives a print request and instructs one of the printers 2 to perform the printing. First, the common printer driver 12 receives a print request (step S21) from the application 11.

Next, the common printer driver 12 acquires the selected printer information 16 stored in the HD 13 (step S22). The common printer driver 12 reads, from the HD 13, the content of the initial property information file 14 or the latest property information file 15 of the model whose name is held as the selected printer information 16, i.e., one of the printers 2 currently selected (step S23). As in the case of the setting process, in the case that the latest property information file 15 for the selected one of the printers 2 already exists, the content of the file is read. In the case that the latest property information file 15 does not exist, the content of the initial property information file 14 is read. In addition, in a case after the model switching process described later, the content of the above file for one of the printers 2 selected by the user is read.

After that, the common printer driver 12 generates a user interface screen for setting the printing condition on the basis of the content of the read file 14 or 15 and displays it on the display device of the host computer 1 (step 24). The user interface screen indicates representative properties of one of the printers 2 and a portion for accepting a request for setting in terms of a specific item for setting the printing condition. The screen has a portion for receiving from the user an instruction for instructing one of the printers 2 to perform the printing after completion of setting of the printing conditions and a portion for receiving the request for model switching similar to the above.

Next, when the user designates the portion for the request for setting of the printing condition in the displayed screen and makes a request for setting the condition, the common printer driver 12 receives the request (Yes in step S25), generates the user interface screen for setting the printing condition, and displays it on the display device (step S26). Here, since the printing conditions include a plurality of items, it is possible that there are one or more portions for accepting the request for setting of the printing conditions and there are one or more user interface screens which are generated and displayed at that time corresponding to the portions.

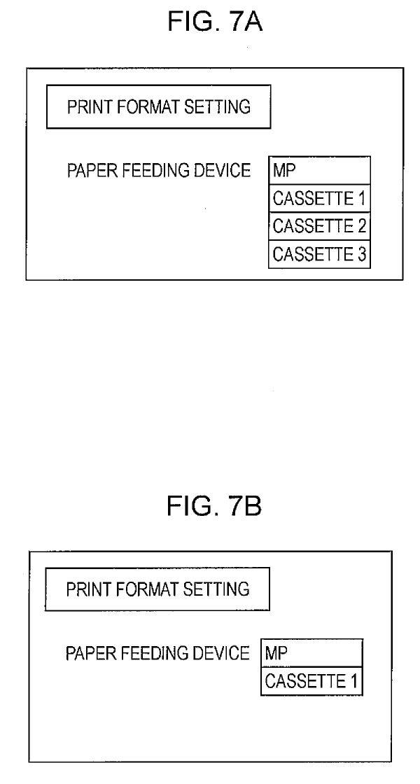

In addition, the user interface screen formed and displayed at that time are formed by using the content of the read initial property information file 14 or latest property information file 15. FIGS. 7A and 7B are schematic views exemplarily showing the user interface screen for setting the conditions. Each of the screens shown in FIGS. 7A and 7B has a portion for setting (designating) the paper feeding device as the printing condition. FIG. 7A shows the content in a case where the latest property information file 15 having the content of FIG. 2C in terms of the printer 2a (model name of “printer A”) is read.

In the above case, as can be seen by the latest information shown in FIG. 2C, the printer 2a is provided with the devices “MP” and “cassette 1” as the regular paper feeding devices and the devices “cassette 2” and “cassette 3” as optional paper feeding devices. Since the paper feeding device to be used can be selected from the above four paper feeding devices, the symbols of the four devices are indicated as the selection candidates. FIG. 7B shows a case in which the latest property information file 15b having the content of FIG. 2D for the printer 2b (model name of “printer B”) is read. Likewise, two operable paper feeding devices are indicated as the selectable candidates in this case.

Thus the latest information about the above described environment setting is reflected in the condition setting screen. In addition, the latest information about the print setting is also reflected in the condition setting screen. For example, in a case where the item indicated at the top of the items in the selection candidates indicated on the condition setting screen is selected as a default item, the item which is set in the latest information relating to the print setting as a default item is indicated at the top of the items. In the paper feeding device shown in FIGS. 7A and 7B, the code “MP” is set in the initial property information file 14 or latest property information file 15 as a default.

When the user selects (sets) a desired printing condition with respect to the displayed screen by using the input device of the host computer 1, the content selected (set) by the user's operation is received (step S27) and a parameter of the selected content is held. For example, the code “MP” is selected in the case shown in FIGS. 7A and 7B, “0” is held as the parameter as shown in FIGS. 2A through 2D.

Thus, the condition setting process is completed. As described above, in the case where there are provided a plurality of portions for accepting the requests for print setting conditions and a plurality of user interface screens, the process from step S25 to step S27 is repeatedly performed in accordance with the user's request.

When the user changes a certain one of the printers 2 to receive the printing instruction in the screen displayed in step S24, the user may designates the portion of receiving the request of the model switching. When the portion is designated and the request of the model switching is received (No in step S25, Yes in step S28), the process (steps S29 and S30) similar to the model switching process (steps S15 and S16) described (FIG. 3) is performed, and then the process is moved to step S23. The process from the reading of the initial property information file 14 or the latest property information file 15 in terms of a certain one of the printers 2 selected by the user is performed.

As described above, the setting process of the printing condition in terms of a certain one of the printers 2 to be used is completed, the portion which is adapted to receive the designation applying the printing instruction to a certain printer of the printers 2 waits for the designation by the user after completion of the setting of the printing condition in the screen displayed in step 24. When the portion is designated and the printing instruction is received (Yes in step S31), the common printer driver 12 generates the print data to be transmitted to the certain one of the printers 2. The print data to be transmitted to the certain one of the printers 2 is configured of data of an image to be printed and a command for control of printing. The held parameter of the printing condition is embedded in the print data. For example, the parameter of “0” indicating that the paper feeding device “MP” should be used, is embedded to the print data. The print data generated in the above described process is transmitted to the selected printer of the printers 2 in accordance with the content of the port setting (step S32). After that, the updating process in which the model of one of the printers 2 which is a target of the printing instruction process is set to the selected printer information 16, is performed.

After that, the print data is received by the certain one of the printers 2.

In a case where the user designates the printing instruction without setting any printing condition on the screen displayed in step S24 (Yes in step S31), the printing instruction according to the content of the printing condition set as the default in the initial property information file 14 or the latest property information file 15, is performed.

It is defined, in the above description, that the latest property information file 15 has information about all of the information items of the initial property information file 14, that is, the latest property information file 15 has all of the property information about the printers 2 necessary for the common printer driver 12. However, it is possible that the latest property information file 15 has only a part of the content of the initial property information file 14, the part being a changed part of the content of the initial property information file 14. In the above case, in order to generate the various kinds of interface screens, the initial property information file 14 and the latest property information file 15 are read in order to be used. As described above, when the latest property information file 15 has the information about all of the information items, it is sufficient to generate the user interface screen only referencing the file 15 after the file 15 is generated. As a result, it is possible to simplify the process of reading the data. Contrary to the above, when the latest property information file 15 has only the changed parts, it is possible to reduce an amount of data to be held.

As described above, the common printer driver 12 according to the embodiment of the invention, accepts a request for setting of a property such as the environment setting or the request for setting of the printing condition in the event of printing, and then generates and displays the user interface for the request by selecting the information regarding the target (selected) printer from the product specification information and the configuration information stored in the host computer 1 by each model of the printers. Therefore, the content according to the property of the model of the targeted certain one of the printers 2 is indicated on the interface screen. As a result, the content according to the property of the model of the targeted one of the printers 2 is indicated in the interface screen and a problem that the content of a printer which is actually not able to be used is indicated, does not occur, thereby improving the usability.

As the configuration information is updated every setting operation and the latest information is held for each model, it is possible to generate the interface screen to which the latest information about the model is reflected, can be generated without changing the configuration information even when the model to be used is changed (switched).

In addition, as the host computer 1 holds the information about the (current) printer in the printers 2 selected at that time, the user does not have to select a certain one of the printers 2 to be used unless the user changes the printer to be used when the common printer driver 12 which is one for the plurality of printers 2.

Further in addition, since only one common printer driver 12 is provided to the plurality of printers 2, it is possible to reduce a storage region in the host computer 1 as compared to a case in which drivers are provided for the respective printers 2, thereby efficiently using the resource of the host computer 1.

In the above embodiment, there is one printer of one model. However, when a plurality of printers of the same model are connected to the host computer 1 to be usable, it is possible to perform similar processes by applying unique names to the plurality of printers. For example, when there are two printers of the model of “printer A” on the network 4, unique names of “printer A at the side of Mr.XX” and “printer A in the center of floor X” are attached to the printers, respectively. In the above case, a user interface for registering unique names is prepared. When a model name and a unique name are input via the interface, the common printer driver 12 generates initial property information files 14 whose number is the number of unique names input therethrough such that the initial property information files 14 corresponding to the model of the printer are copied and the model name of the printer is changed to the input unique name. After that, the processes are performed similarly to the case of the above embodiment. In addition, even when there is actually one printer of one model, it is possible that a plurality of names are registered for the model and that the plurality of initial property information files 14 and the latest property information files 15 generated thereafter are prepared. At that time, under a condition that the contents of the above print setting of the respective latest property information files 15 differ from each other, desired printing can be performed by selecting the model name by selecting the model name of the latest property information file 15 in which the conditions are set as default information without selecting each print condition suitable for the purpose at the time when printing using a printer of the same model.

In addition, in a case where sales of printers of a new model (model name of “printer X”) is started from a manufacturer of printers, an initial property information file 14X corresponding to the new model of “printer X” is added to the common printer driver 12 of the host computer 1. With the above configuration, the common printer driver 12 can be made one adaptable to the already existing models and the new model without installing a new common printer driver. In the above case, a menu for adding a new model may be prepared as a menu of the common printer driver 12. When a user carries out designation for adding the new model via the menu, the common printer driver accesses the manufacturer's site 3. As a result, an initial property information file which is provided from the manufacturer's site 3 and is not yet installed in the host computer 1 may be added to the initial property information file of the common printer driver in the host computer 1. It is possible for the user to select the initial property information file to be added.

Note that the invention is not limited to the above described embodiments, but includes all modifications and equivalents within the spirit and scope of the appended claims

The entire disclosure of Japanese Patent Application No. 2008-152033, filed Jun. 10, 2008 is expressly incorporated by reference herein.

What is claimed is:

1. A printing instruction device for performing a printing instruction process for a plurality of models of printers, the device comprising:
a data storage unit that stores product specification information provided from a manufacturer of the printers by each of the models and configuration information which is able to be set by a user and is the latest information regarding property information about the printers; and
a control unit that generates and displays a user interface screen based on the product specification information and the configuration information in accordance with a selected printer in response to a request made by the user.

2. The printing instruction device according to claim 1, further comprising:
a update unit that updates the information about the selected printer to be information about the printer which is a target of the printing instruction process or the setting process of the configuration information every time the processes are performed, and then to hold the updated information.

3. The printing instruction device according to claim 1, wherein the request made by the user is a request for setting of the configuration information or a request for setting of a printing condition when performing the printing instruction process.

4. The printing instruction device according to claim 1, wherein the configuration information includes information relating to an attachment state of an optional device of the printer and information relating to a printing condition selected as a default when performing the printing instruction process.

5. A computer readable medium encoded a printer driver program that allows a host device to perform a printing instruction process for a plurality of models of printers, the printer driver program comprising:
a program part that allows the host device to perform a process of holding product specification information provided from a manufacturer of the printers for each of the models and latest configuration information which is property information about each of the printers and is settable by a user; and
a program part that allows the host device to perform a process of generating and displaying a user interface screen based on the product specification information and the configuration information relating to a selected printer in response to a request made by the user.
